(19) United States
(12) Patent Application Publication
(10) Pub. No.: US 2010/0030348 A1
(43) Pub. Date: Feb. 4, 2010

(54) METHOD AND SYSTEM FOR INTEGRATED CONTROL OF MACHINE OPERATIONS

(76) Inventor: Jerry Gene Scherer, Ashton, IL (US)

Correspondence Address: General Electric Company;GE Global Patent Operation, PO Box 861, 2 Corporate Drive, Suite 648, Shelton, CT, 06484, US

(21) Appl. No.: 12/182,397

(22) Filed: Jul. 30, 2008

(51) Int. Cl. G05B 11/32; G08B 21/18; G05B 15/02

(52) U.S. Cl. 700/70; 340/680; 700/83; 700/160

(57) ABSTRACT

A method and system for a machine tool system are provided. The system includes a spindle, one or more sensor devices configured to determine a value of an operating parameter of the system, and a software application embedded within a control program of the machine tool system. The software application includes a process controller integration module configured to receive the determined operating parameter value from the sensor device, compare the operating parameter value to a predetermined allowable range, and generate one or more alerts using the comparison. The software application also includes a GUI interface module configured to display the alerts in at least one of a graphical and a textual form on a display of the machine tool system. The GUI interface module is further configured to communicate user inputs to the process controller integration module and receive information for user displays from the process controller integration module.

### BACKGROUND OF THE INVENTION

This invention relates generally to controlling a computer numerical control (CNC) machine and, more particularly, to monitoring and control applications embedded in a CNC controller.

At least some known CNC machines monitor various parameters relating to the operation of the CNC machine. Typically such monitoring occurs using sensors and a controller that are external and separate from the CNC controller. Because the monitoring equipment is separate from the CNC controller timing and interface coordination is necessary. However, CNC machine control programs are generally inaccessible to a user, therefore timing and interface modification may be time consuming, and costly if the user is required to rely on the manufacturer to connect a detection piece of hardware to the CNC machine for alarm detection. Additionally, custom reports based on alarm events and the ability to transfer and generate reports may also be affected by the closed nature of the CNC controller software. The ability to monitor CNC machine operating parameters has been implemented in the past using external devices, for example, programmable logic controllers (PLC) or PC application software. Such monitoring has been implemented as external hardware or software add-ons retrofitted to existing CNC operated machines but not embedded into the device itself where it has access to all aspects of the system parameters.

### BRIEF DESCRIPTION OF THE INVENTION

In one embodiment, a machine tool system includes a spindle, one or more sensor devices, and a software application embedded within a control program of the machine tool system. The spindle is configured to rotate about an axis and to receive a tool head interchangeably therein. The one or more sensor devices are configured to determine a value of an operating parameter of the system that includes at least one of a speed of rotation of the spindle and a torsional load on the spindle. The software application is embedded within a control program of the machine tool system and includes a process controller integration module and a GUI interface module. The process controller integration module is communicatively coupled to the sensor device through an input output device of the machine tool system and is configured to receive the determined operating parameter value from the sensor device, compare the operating parameter value to a predetermined allowable range, and generate one or more alerts using the comparison. The GUI interface module is communicatively coupled to the process controller integration module and is configured to display the one or more alerts in at least one of a graphical and a textual form on a display of the machine tool system. The GUI interface module is further configured to communicate user inputs to the process controller integration module and receive information for user displays from the process controller integration module.

In another embodiment, a method of controlling a machining operation on a workpiece by a machine tool using an application embedded within a controller of the machine tool includes receiving an operating parameter of the machine tool from a machine tool sensor by the application embedded within a controller of the turning tool, comparing in the embedded application, the received operating parameter to at least one of a respective first predetermined allowable range and a second predetermined allowable range, generating by the embedded application, a first alert if the received operating parameter exceeds the first predetermined allowable range for a first predetermined period of time, and outputting the first alert through a resource of the machine tool.

In yet another embodiment, a computer program embodied on a computer-readable medium including a code segment that configures a processor to control a machining operation on a workpiece by a machine tool is provided. The code segment executes as an application embedded within a controller of the machine tool and configures the processor to receive an operating parameter of the machine tool from a machine tool sensor by the application embedded within a controller of the turning tool, compare in the embedded application, the received operating parameter to at least one of a respective first predetermined allowable range and a second predetermined allowable range, generate by the embedded application, at least one of a first alert if the received operating parameter exceeds the first predetermined allowable range for a first predetermined period of time and a second alert if the received operating parameter exceeds the second predetermined allowable range for a second predetermined period of time, and output at least one of the first alert and the second alert through a resource of the machine tool.

### BRIEF DESCRIPTION OF THE DRAWINGS

FIGS. 1-3 show exemplary embodiments of the method and system described herein.

FIG. 1 is a schematic block diagram of a computer numerical control (CNC) system in accordance with an exemplary embodiment of the present invention;

FIG. 2 is a flow diagram of an exemplary method of monitoring process parameters of a turning operation using a process monitoring module embedded in a computer numerical control machine controller; and

FIG. 3 is a flow diagram of another exemplary method of controlling a turning operation on a workpiece by a turning tool using an application embedded within a controller of the turning tool.

### DETAILED DESCRIPTION OF THE INVENTION

The following detailed description illustrates embodiments of the invention by way of example and not by way of limitation. It is contemplated that embodiments of the invention have general application to analytical and methodical embodiments of monitoring machine operating parameters and generating alerts using embedded applications when the operating parameters exceed allowable ranges in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

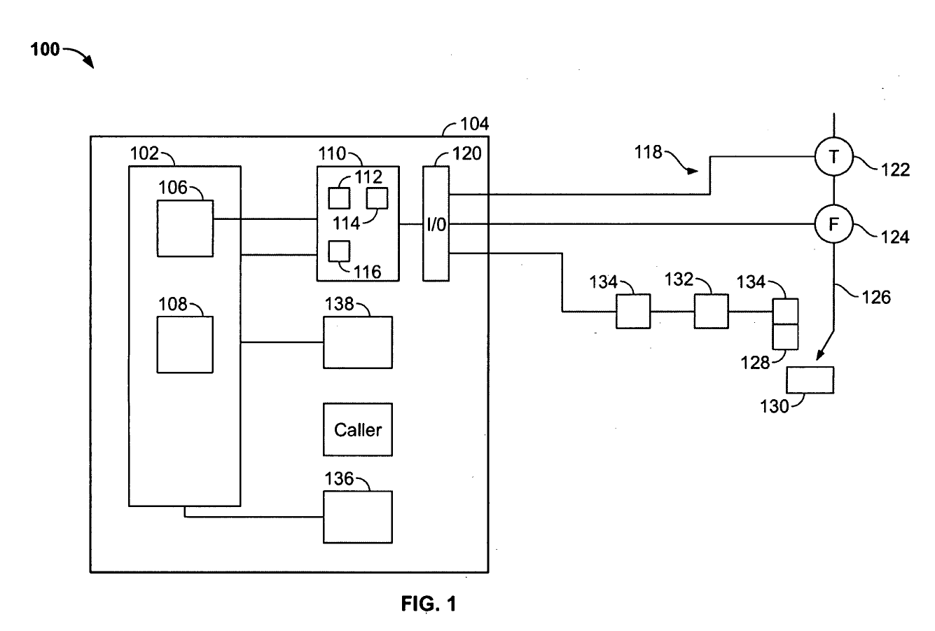

FIG. 1 is a schematic block diagram of a computer numerical control (CNC) system 100 in accordance with an exemplary embodiment of the present invention. In the exemplary embodiment, system 100 includes a process monitoring software module 102 implemented as an embedded multi-tasking application within a controller 104 of computer numerical control system 100. Process monitoring software module 102 includes a graphical user interface (GUI) 106 and a process controller (PMC) integration software module 108. GUI 106 permits a user to view and interpret alert and process information. GUI 106 generates screen displays that are used to output operating parameters of system 100 for use by the user. Additionally, GUI 106 may include drivers and/or code for receiving inputs from the user for use by a process controller 110. Process controller 110 includes a processor 112, a display device 114 communicatively coupled to processor 112, and an input device 116 such as a keyboard or mouse for example. In one embodiment, a touch screen communicatively coupled to GUI 106 is used to provide input to system 100. In an alternative embodiment, GUI 106 may be incorporated into display device 114 such that a user can depress buttons or touch icons displayed on display device 114 to initiate commands performed by processor 112. Process controller 110 is communicatively coupled to a plurality of CNC sensors 118 through an input/output (I/O) device 120.

I/O device 120 is communicatively coupled to coolant condition sensors such as but not limited to a temperature sensor 122 and a flow sensor 124. Temperature sensor 122 and flow sensor 124 monitor respective coolant conditions in a coolant supply line 126 that channels coolant to an interface between a tool head 128 and a workpiece 130. A motor 132 is configured to turn a spindle 134 coupled between motor 132 and tool head 128 in response to commands received from process controller 110. A motor driver 135 may be used to facilitate control of motor 132. A rotational speed of spindle 134 and a torsional load on spindle 134 due to a machining operation, for example, a turning operation are monitored and a spindle speed signal and a spindle load signal are generated and transmitted to process monitoring software module 102. In the exemplary embodiment, process monitoring software module 102 includes a detection algorithm that monitors the spindle speed, the spindle load and the coolant performance during machining of for example, holes in critical parts. If the spindle speed deviates from a predetermined programmed value by an amount configured by the user, a speed alarm is generated in CNC controller 104. Moreover, if the load on spindle 134 exceeds a predetermined warning level (yellow limit) or alarm level (red limit) for a configured period of time, an alert is generated in CNC controller 104. Further, if coolant flow is not detected for a configured period of time, an alarm is generated. In an alternative embodiment, a coolant temperature exceeding a predetermined range for a configurable period of time also generates an alarm. The alarms are generated within CNC controller 104 and acted upon by CNC controller 104 to prevent further operation of system 100 until the alarm conditions are alleviated or the alarm condition is acknowledged by the user. The torsional load on spindle 134 may be monitored using a force sensor coupled directly to spindle 134 or may be monitored using an electrical power monitor (not shown) associated with a power supply to motor 132 and/or motor driver 135. The electrical power monitor is configured to receive electrical power signals such as but not limited to voltage, current, and/or power factor to determine the torsional load on spindle 134.

In the exemplary embodiment, CNC controller 104 includes an embedded C-Language Executor feature 138 that enables the capabilities of detection algorithms within CNC controller 104 to be made available to system 100 without the assistance of external hardware. Accordingly, process monitoring software module 102 detection algorithm application includes no hardware directly associated with it. Embedded C-Language Executor feature 138 permits user programming in C language, permits machine tool builders to generate unique screen displays that can be used to replace the standard CNC screens, supports multiwindow displays and permits generating operational screens using a touch panel on CNC controller 104.

In one embodiment, the detection algorithm application is loaded by the factory. In various embodiments, the detection algorithm application is loaded by the machine tool builder or in the field by an installation engineer. The detection algorithm application is provided in an executable form and is activated using a set of option activation bits 136 in CNC controller 104. Controlling access to the detection algorithm application using option activation bits 136 limits the use of detection algorithm application to paid customers only.

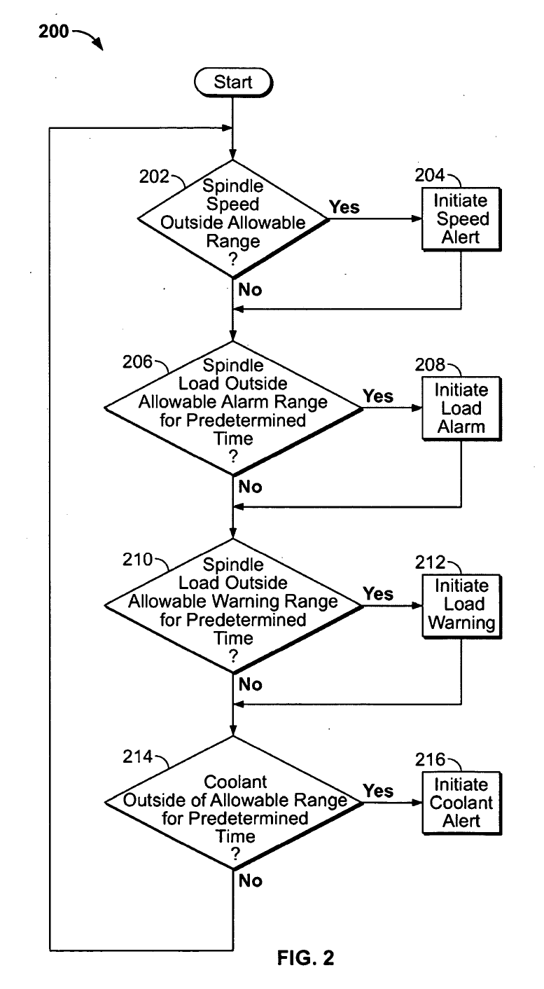

FIG. 2 is a flow diagram of an exemplary method 200 of monitoring process parameters of a turning operation using a process monitoring module embedded in a computer numerical control machine controller. In the exemplary embodiment, method 200 includes determining 202 if a spindle of a CNC machine is rotating outside a predetermined allowable range. If the rotating speed of the spindle is outside the allowable range for the spindle speed, a spindle speed alert sequence is initiated 204. During the spindle speed alert sequence, a timer is initiated and if the rotating speed remains outside the allowable range during the period the timer is operating (incrementing or decrementing) an alert is initiated when the timer reaches a predetermined count. Depending on the amount by which the spindle speed exceeds the allowable range the alert may be a warning alert or may be an alarm alert. The actions proscribed by different alerts may include differing levels of automatic intervention of the operation of the CNC machine. For example, a warning alert may only apprise the user of the existence of a particular condition, permitting the user to take action manually, if appropriate. An alarm alert may cause an automatic shutdown of the CNC machine or an emergency stop of the CNC machine. The monitoring of the spindle speed, the timer function, and the generation of the alerts are all performed within the CNC controller using a process monitoring software module detection algorithm application executing on an embedded C-Language Executor feature that enables the capabilities of detection algorithms within the CNC controller to be made available to the CNC machine without using external hardware. Accordingly, the monitoring of the speed of the spindle, the detection of the operation outside an allowable range, the generation of alerts, and the control action taken by the CNC controller as a result of the alerts are performed within the CNC controller using the CNC controller resources and benefiting from the speed of the CNC controller buses without the signal transmission speed penalties associated with external or add-on devices.

Method 200 also includes determining 206 if a load on the spindle exceeds a predetermined allowable range. If the load on the spindle is outside a first allowable range for the spindle load, a spindle load alarm alert sequence is initiated 208. If the load on the spindle is determined 210 to be outside a second allowable range for the spindle load, a spindle load warning alert sequence is initiated 212. If a flow of coolant or a temperature of coolant is determined 214 to be outside of respective predetermined ranges, a coolant alert sequence is initiated 216. A severity of a loss of coolant is evaluated and an alert generated based on the severity. For example, an increase in the temperature of the coolant while full flow is maintained may not be determined to be as severe as a partial or complete loss of flow.

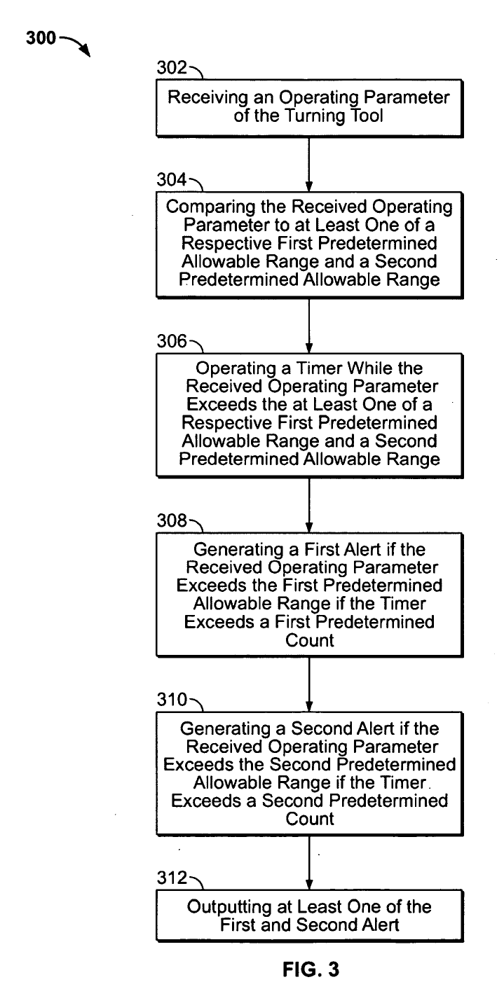

FIG. 3 is a flow diagram of another exemplary method 300 of controlling a turning operation on a workpiece by a turning tool using an application embedded within a controller of the turning tool. In the exemplary embodiment, method 300 includes receiving 302 an operating parameter of the turning tool, such as but not limited to a spindle speed, a spindle load, a coolant flow, and a coolant temperature. Method 300 also includes comparing 304 the received operating parameter to at least one of a respective first predetermined allowable range and a second predetermined allowable range, operating 306 a timer while the received operating parameter exceeds the at least one of a respective first predetermined allowable range and a second predetermined allowable range, and generating 308 a first alert if the received operating parameter exceeds the first predetermined allowable range if the timer exceeds a first predetermined count. Method 300 further includes generating 310 a second alert if the received operating parameter exceeds the second predetermined allowable range if the timer exceeds a second predetermined count and outputting 312 at least one of the first and second alert.

The various embodiments of controller 104, or the components thereof, may be implemented as a part of a computer system. The computer system may be housed within an enclosure of controller 104 and/or located remotely from CNC system 100, such as, for example, at a centralized control center. The computer system may include a computer, an input device, a display unit, and an interface, for example, to access the Internet. The computer system may also include a processor, which may be connected to a communication bus. The computer may include a memory, which may include a Random Access Memory (RAM) and a Read Only Memory (ROM), as well as a storage device, which may be a hard disk drive or a removable storage drive such as a floppy disk drive, an optical disk drive, and so forth. The storage device is configured to load computer programs and/or other instructions into the computer system. As used herein, the term “processor” is not limited to only integrated circuits referred to in the art as a processor, but broadly refers to central processing units, microprocessors, microcontrollers, reduced instruction set circuits (RISC), application specific integrated circuits (ASIC), logic circuits, computers, microcomputers, programmable logic controllers, and any other circuit or processor capable of executing the functions described herein.

The computer system executes instructions, stored in one or more storage elements, to process input data. The storage elements may also hold data or other information, as desired or required, and may be in the form of an information source or a physical memory element in the processing machine. The set of instructions may include various commands that instruct the computer system to perform specific operations, such as the processes of a method. The set of instructions may be in the form of a software program. The software may be in various forms, such as system software or application software. Further, the software may be in the form of a collection of separate programs, a program module within a larger program, or a portion of a program module. The software may also include modular programming in the form of object-oriented programming. The processing of input data by the processing machine may be in response to user commands, to results of previous processing, or to a request made by another processing machine.

As will be appreciated by one skilled in the art and based on the foregoing specification, the above-described embodiments of the invention may be implemented using computer programming or engineering techniques including computer software, firmware, hardware or any combination or subset thereof that is configured to control various components of a system machining parts and/or components. Any resulting program, having computer-readable code means, may be embodied or provided within one or more computer-readable media, thereby making a computer program product, i.e., an article of manufacture, according to the discussed embodiments of the invention. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

As used herein, the terms “software,” “application,” and “firmware” are interchangeable, and include any computer program stored in memory for execution by processor 112, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is controlling a machining operation on a workpiece by a machine tool using an application embedded within a controller of the machine tool. A controller of the machine tool receives the embedded application, which includes a process monitoring module and a graphical user interface. In one embodiment the embedded application is written in C-language programming and operates through an executor operating on the controller of the machine tool. The application receives operating parameters associated with the machine tool from sensors on the machine tool through the machine tool resources. The received operating parameters are compared in the embedded application, to one or more respective predetermined allowable ranges. If any of the received operating parameters are detected outside the respective allowed range, a timer is initiated. If any of the received operating parameters remain outside the allowable range for the duration that the timer takes to reach a predetermined count, an alert is generated. The alert is communicated using a resource of the machine tool. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of controlling a turning operation on a workpiece by a turning tool using an application embedded within a controller of the turning tool provides a cost-effective and reliable means for interrogating the process controller (PMC) and the I/O, directly using a software module embedded in the control software of the CNC controller facilitates removing time delays and interface issues associated with external hardware integration. More specifically, the method and system described herein facilitate communicating the alert and process information using the CNC controller's own resources. As a result, the method and system described herein facilitate controlling a machine tool in a cost-effective and reliable manner.

An exemplary method and system for controlling a machine tool using an application embedded within a controller of the machine tool are described above in detail. The apparatus illustrated is not limited to the specific embodiments described herein, but rather, components of each may be utilized independently and separately from other components described herein. Each system component can also be used in combination with other system components.

While the disclosure has been described in terms of various specific embodiments, it will be recognized that the disclosure can be practiced with modification within the spirit and scope of the claims.

What is claimed is:

1. A machine tool system comprising:
a spindle configured to rotate about an axis, said spindle configured to receive a tool head interchangeably therein;
one or more sensor devices configured to determine a value of an operating parameter of the system that includes at least one of a speed of rotation of the spindle and a torsional load on the spindle;
a software application embedded within a control program of the machine tool system, said software application comprising:
a process controller integration module communicatively coupled to said sensor device through an input output device of the machine tool system, said process controller module configured to:
receive the determined operating parameter value from the sensor device;
compare the operating parameter value to a predetermined allowable range; and
generate one or more alerts using the comparison; and
a GUI interface module communicatively coupled to said process controller integration module, said GUI interface module configured to display the one or more alerts in at least one of a graphical and a textual form on a display of the machine tool system, said GUI interface module further configured to communicate user inputs to said process controller integration module and receive information for user displays from said process controller integration module.

2. A system in accordance with claim 1 wherein said sensor device is configured to determine an electrical power input to a motor drive coupled to said spindle.

3. A system in accordance with claim 1 wherein said sensor device is configured to determine a value of an operating parameter that includes at least one of a flow of a coolant to a tool head coupled to the spindle, a temperature of the flow of the coolant, and a temperature of an interface between the tool head and a workpiece.

4. A system in accordance with claim 3 wherein said process controller module is further configured to compare at least one of the flow of the coolant, the temperature of the flow, and the temperature of the interface to a respective predetermined allowable range for the determined operating parameter.

5. A system in accordance with claim 1 wherein said process controller module is further configured to compare at least one of the speed of rotation of the spindle to a predetermined allowable range for the speed of rotation of the spindle and the torsional load on the spindle to a predetermined allowable range for the torsional load on the spindle.

6. A system in accordance with claim 1 wherein said process controller module is further configured to generate one or more alerts using the comparison and a predetermined time period that the operating parameter value is outside the respective predetermined allowable range for that operating parameter value.

7. A system in accordance with claim 1 wherein the one or more alerts includes a signal that initiates a shutdown of the machine tool system.

8. A system in accordance with claim 1 wherein the one or more alerts includes a signal that annunciates a warning.

9. A system in accordance with claim 1 wherein the user displays are generated by the GUI and are configured to be displayed using an output device of the machine tool system.

10. A method of controlling a machining operation on a workpiece by a machine tool using an application embedded within a controller of the machine tool, said method comprises:
receiving an operating parameter of the machine tool from a machine tool sensor by the application embedded within a controller of the turning tool;
comparing in the embedded application, the received operating parameter to at least one of a respective first predetermined allowable range and a second predetermined allowable range;
generating by the embedded application, a first alert if the received operating parameter exceeds the first predetermined allowable range for a first predetermined period of time; and
outputting the first alert through a resource of the machine tool.

11. A method in accordance with claim 10 wherein the machine tool includes a rotatable spindle and wherein receiving an operating parameter of the machine tool comprises receiving at least one of a speed of the spindle, a load on the spindle due to the machine operation, and a flow of coolant to at least one of the machine tool and the workpiece;

12. A method in accordance with claim 10 wherein comparing the received operating parameter comprises comparing at least one of a speed of a spindle of the machine tool, a load on the spindle due to the machine operation, and a flow of coolant to at least one of the machine tool and the workpiece to a respective predetermined allowable range.

13. A method in accordance with claim 10 further comprising operating a timer while the received operating parameter exceeds the at least one of a respective first predetermined allowable range and a second predetermined allowable range.

14. A method in accordance with claim 10 further comprising generating a second alert if the received operating parameter exceeds the second predetermined allowable range for a second predetermined period of time.

15. A method in accordance with claim 10 wherein receiving an operating parameter of the machine tool comprises receiving the operating parameter through an input of the controller by a monitoring application executing on the controller.

16. A method in accordance with claim 10 wherein outputting at least one of the first and second alert comprises outputting the at least one of the first and the second alert on a display screen of the controller using a graphical user interface (GUI) executing on the controller.

17. A computer program embodied on a computer-readable medium, said computer program comprising a code segment that configures a processor to control a machining operation on a workpiece by a machine tool wherein the code segment executes as an application embedded within a controller of the machine tool, said code segment further configures the processor to:
receive an operating parameter of the machine tool from a machine tool sensor by the application embedded within a controller of the turning tool;
compare in the embedded application, the received operating parameter to at least one of a respective first predetermined allowable range and a second predetermined allowable range;
generate by the embedded application, at least one of a first alert if the received operating parameter exceeds the first predetermined allowable range for a first predetermined period of time and a second alert if the received operating parameter exceeds the second predetermined allowable range for a second predetermined period of time; and
output at least one of the first alert and the second alert through a resource of the machine tool.

18. A computer program in accordance with claim 17 wherein the machine tool includes a spindle rotatable about an axis and a tool head coupled to the spindle and configured to engage a workpiece, the machine tool further includes a source of coolant flow to an interface between the tool head and the workpiece, the computer program further comprising at least one code segment that configures the processor to receive an operating parameter including at least one of a spindle rotation speed, a spindle load, and a coolant flow from a machine tool sensor associated with the operating parameter.

19. A computer program in accordance with claim 17 wherein the computer program further comprises at least one code segment that configures the processor to accumulate the received operating parameters over a predetermined third period of time and to communicate the accumulated data through a graphical user interface for generation of a production report.

20. A computer program in accordance with claim 17 wherein the computer program further comprises at least one code segment that configures the processor to receive user inputs for one or more of the first predetermined allowable range, the first predetermined period of time, the second predetermined allowable range, the second predetermined period of time, and the third predetermined period of time.
